(19) United States
(12) Patent Application Publication
(10) Pub. No.: US 2024/0299965 A1
(43) Pub. Date: Sep. 12, 2024

(54) SPRAY ASSEMBLY FOR A MEAT SMOKER SYSTEM

(71) Applicant: David Story, Grinnell, IA (US)

(72) Inventor: David Story, Grinnell, IA (US)

(21) Appl. No.: 18/601,740

(22) Filed: Mar. 11, 2024

Related U.S. Application Data
(60) Provisional application No. 63/489,198, filed on Mar. 9, 2023.

(51) Int. Cl. B05B 12/00; B05B 1/20

(52) U.S. Cl. CPC B05B 12/004; B05B 1/20

(57) ABSTRACT

The various aspects disclosed herein relate to a spray assembly for a meat smoker assembly that pumps a liquid through one or more nozzle to keep a meat product or other food moist. Certain aspects relate to a spray controller that is configurable with defined and/or predefined settings that relate to a length of time (i.e., total time), a defined interval between pump activations, and a defined duration of pump activation. The predefined settings may also be based on user input, such as a type of meat product. Other aspects relate to a compact configuration of the spray assembly that nests components within a control housing. Still other aspects relate to the removable nature of some of the components as well as removable connection of the spray assembly to and from a meat smoker system.

### CROSS REFERENCE TO RELATED APPLICATION

This application claims the benefit U.S. Provisional Application Ser. No. 63/489,198 filed Mar. 9, 2024, the contents of these applications are hereby incorporated by reference in their entirety.

### FIELD OF INVENTION

This disclosure generally relates to a spray assembly for a meat smoker. More specifically, the disclosure relates to a spray assembly for a meat smoker that is configurable to provide automated application of liquid at definable intervals and definable lengths. Although the present disclosure provides a description related to meats, any food product subject to cooking is contemplated within the scope of the disclosure.

### BACKGROUND OF THE INVENTION

Meat smokers are known in the art and are used to prepare meats of various kinds. While there are numerous ways to prepare meats and foods generally, a smoker provides the advantage of providing a slow cooking process at low temperatures where the meat is exposed to smoke created by burning wood, such as wood chips and/or wood pellets. The exposure to smoke enhances the flavor of the meat that is not otherwise possible through other methods of cooking, e.g., grilling with propane.

Although useful, effective smoking requires that the meat is cooked for extended periods of time to allow the smoke to penetrate the meat, which can result in the meat becoming dry throughout the cooking process. Similarly, the dried-out meat will not properly form a bark that is pleasant to eat and is likely to simply burn or char, thereby leaving the meat with an unpleasant taste. In addition, meat that is dried out will not infuse with smoke as effectively, which undermines the purpose of smoking the meat.

One advancement that has taken place to address this problem is to spray the meat during the smoking process. Conventionally, this is accomplished by the cook routinely opening the smoker and manually spraying the meat with a liquid, such as water or a flavoring.

This approach has deficiencies. The repeated process can be difficult to sustain, let alone at consistent intervals, as smoking can last for many hours and sometimes takes place overnight. Moreover, meats vary on the amount of liquid that is required to remain moist and determining the amount of liquid applied during a manual spraying is difficult to ascertain. Accordingly, the cook can easily ruin a time intensive and financially costly smoke by mistiming a spray, forgetting to spray altogether or at a particular interval, or failing to adequately spray the meat during a specific application.

Thus it is a primary aspect of this disclosure to provide a spray assembly for a meat smoker system that improves upon the art.

Another aspect of this disclosure is to provide a spray assembly for a meat smoker system that is programmable to apply a spray of a liquid at a definable interval of time and/or a definable amount of the liquid.

Yet another aspect of this disclosure is to provide a spray assembly for a meat smoker system that can be retrofitted to the meat smoker system.

Another aspect of this disclosure is to provide a spray assembly for a meat smoker system that is user friendly.

Yet another aspect of this disclosure is to provide a spray assembly for a meat smoker system that is cost-effective.

Another aspect of this disclosure is to provide a spray assembly for a meat smoker system that is easily maintained.

These and other aspects, features, and advantages of the invention will become apparent from the specification and claims.

### SUMMARY OF THE INVENTION

The disclosure provides various aspects of a spray assembly for a meat smoker system.

In Example 1, a spray assembly for a meat smoker system comprises a control housing that has a compartment with an interior. Connected to the control housing is a power controller and a spray controller. Inside the compartment of the control housing is a power supply, a pump, and a reservoir. The spray controller is configured to operate the pump to draw a liquid contained in the reservoir and discharge the liquid through a nozzle.

Example 2 relates to the spray assembly for a meat smoker according to Example 1, further comprising the power controller and the spray controller being positioned through a door of the control housing. When the door is closed the spray controller and the power controller nest with the power supply, the pump, and the reservoir within the control housing.

Example 3 relates to the spray assembly for a meat smoker according to Example 1 wherein the spray controller is configured to activate the pump for a defined length of time, a defined interval between activation of the pump, and a defined duration of activation of the pump.

Example 4 relates to the spray assembly for a meat smoker according to Example 1 wherein the spray controller is configured to activate the operation of the pump for a predefined length of time, a predefined interval between activation of the pump, and a predefined duration of activation of the pump.

Example 5 relates to the spray assembly for a meat smoker according to Example 4 wherein the predefined length, the predefined interval, and the predefined duration is based on a user input.

Example 6 relates to the spray assembly for a meat smoker according to Example 5 wherein the user input is a weight of a meat product.

Example 7 relates to the spray assembly for a meat smoker according to Example 6 wherein the user input is a type of a meat product.

Example 8 relates to the spray assembly for a meat smoker according to Example 1 wherein the spray controller is configured to activate the pump based on a defined setting and a predefined setting.

Example 9 relates to the spray assembly for a meat smoker according to Example 1 further comprising the pump connected to an external distribution tubing that connects to an internal distribution tubing. The internal distribution tubing has the nozzle.

Example 10 relates to the spray assembly for a meat smoker according to Example 9 further comprising the external distribution tubing having a distribution outlet port that couples with the internal distribution tubing with a compression fit so that the external distribution tubing is manually removable.

Example 11 relates to the spray assembly for a meat smoker according to Example 1 further comprising a rear of the control housing having a bumper assembly and a hanger.

Example 12 relates to the spray assembly for a meat smoker according to Example 11 wherein the bumper assembly is configured to maintain the control housing in an upright position when the hanger is hung from a meat smoker assembly.

Example 13 relates to the spray assembly for a meat smoker according to Example 1 wherein the nozzle is configured to discharge the liquid in a conical pattern.

Example 14 relates to the spray assembly for a meat smoker according to Example 1 wherein the nozzle comprises a pair of nozzles positioned equidistantly along an internal distribution tubing.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a front view of a spray assembly for a meat smoker system according to an aspect of the disclosure;

FIG. 2 is a front view of a spray assembly for a meat smoker system connected to a meat smoker system according to an aspect of the disclosure;

FIG. 3 is a front view of a spray assembly for a meat smoker system according to an aspect of the disclosure;

FIG. 4A is a front view of a spray assembly for a meat smoker system according to an aspect of the disclosure;

FIG. 4B is a front view of a spray assembly for a meat smoker system according to an aspect of the disclosure;

FIG. 5 is a rear view of a spray assembly for a meat smoker system according to an aspect of the disclosure;

FIG. 6 is a side view of a spray assembly for a meat smoker system according to an aspect of the disclosure;

FIG. 7 is a side view of a spray assembly for a meat smoker system according to an aspect of the disclosure;

FIG. 8 is a side view of a spray assembly for a meat smoker system according to an aspect of the disclosure;

FIG. 9 is a side view of a spray assembly for a meat smoker system according to an aspect of the disclosure;

FIG. 10 is a side view of a spray assembly for a meat smoker system according to an aspect of the disclosure;

FIG. 11 is a perspective view of a spray assembly for a meat smoker system connected to a meat smoker system according to an aspect of the disclosure;

FIG. 12 is a perspective view of a spray assembly for a meat smoker system connected to a meat smoker system according to an aspect of the disclosure;

FIG. 13 is a rear view of a hanger of a spray assembly for a meat smoker system connected to a meat smoker system according to an aspect of the disclosure;

FIG. 14 is a side view of a hanger of a spray assembly for a meat smoker system connected to a meat smoker system according to an aspect of the disclosure; and

FIG. 15 is a top perspective view of a hanger of a spray assembly for a meat smoker system connected to a meat smoker system according to an aspect of the disclosure.

### DETAILED DESCRIPTION

The disclosure described herein is directed to different aspects of a spray assembly for a meat smoker system. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. In particular, the disclosure is described herein in regards to a meat smoker system, but it is understood that the disclosure can relate to any variety of cooking system, including a grill, oven, or the like, where food products are brought to a desired temperature.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

Aspects of the disclosure may be described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

With reference to the Figures aspects of a spray assembly 10 for a meat smoker system 12 are disclosed. The spray assembly 10 is configured to automatically apply a liquid 16 in a spray or spritz to a food product or a meat product 18. The spray assembly 10 is configured to apply the liquid 16 in definable intervals of time and/or a definable length of time and/or a definable amount or volume of the liquid 16. Aspects of the spray assembly 10 will be described with further detail herein.

The spray assembly 10 may comprise one or more of a control housing 20, a power controller 22, a spray controller 24, a power supply or battery 26, a pump 28, a reservoir 30, a reservoir holder 32, a reservoir tubing 34, an external distribution tubing 36, an internal distribution tubing 38, a nozzle 40, a housing lock 42, a hanger 44, and/or a bumper assembly 46. As discussed, the spray assembly 10 is contemplated for use with a meat smoker system 12, which can take various forms.

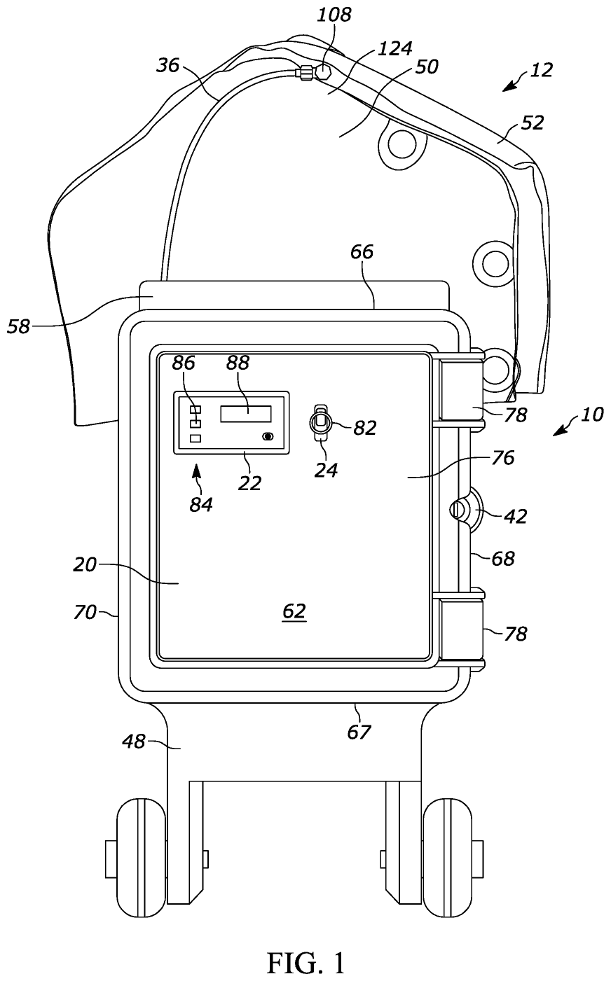

With respect to the aspects described herein, the meat smoker system 12, as seen in FIG. 1, is depicted having a frame 48 connected to a smoke chamber 50. The smoke chamber 50 has a smoke chamber lid 52 that provides access to a grill grate 54 positioned above a firepit 56 (not shown) that produces heat from a fuel source (such as wood pellets or chips) contained in a hopper or firebox 58 that are fed into the firepit 56 by an auger or a conveyor 60 (not shown) to create smoke and/or heat during a cook.

FIG. 1 also shows the control housing 20 connected to the firebox 58 of the meat smoker system 12. The control housing 20 comprises a front 62, a rear 64, a top 66, a bottom 67, a first side 68, and second side 70 that form a compartment 72 having an interior 74.

As shown, the front 62 of the control housing 20 may comprise a door 76 that provides access to the interior 74 of the control housing 20. The control housing 20 may comprise a lock or a plurality of locks 78 to secure the door 76 to the rest of the control housing 20 on the first side 68. On the opposing or the second side 70 a hinge or a plurality of hinges 80 connected the door 76 to the control housing 20.

The control housing 20 in some aspects is sized and shaped to attach to the meat smoker system 12, such as by attachment to the smoke chamber 50 or the firebox 58 such that the control housing 20 does not extend in front of or to the rear of the meat smoker system 12. In this way, the likelihood of a user running into the control housing 20 is minimized. In particular aspects, the control housing 20 is formed of a polycarbonate material thereby being temperature resistant in regard to the transfer of heat from the meat smoker system 12 to the control housing 20 as well as from the environment. Additionally, the use of a polycarbonate material reduces the weight of the spray assembly 10 while protecting one or more of the other aspects of the spray assembly 10 discussed herein. In other aspects, the control housing 20 has a rectangular and/or square shape. For example, the control housing 20 may be approximately 10.2 inches tall by 11.8 inches wide with a depth of 5.5 inches. Such dimensions provide the interior 74 of the control housing 20 with sufficient room to accommodate the various elements disclosed herein to allow operation during a long cook without refilling the liquid 16 as described herein while also avoiding being overly confined as to make refilling of the liquid 16 during or after a cook difficult and/or time consuming.

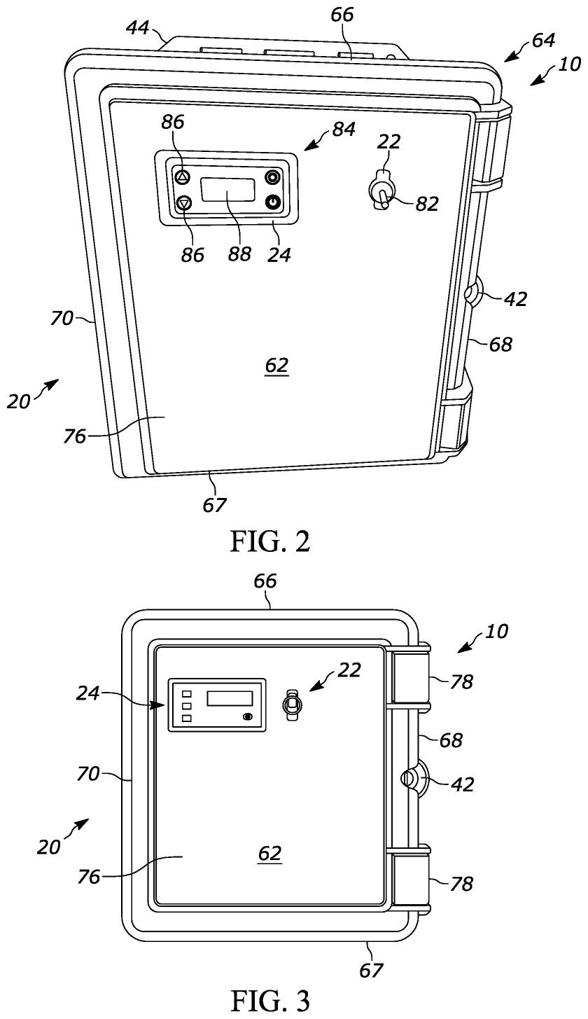

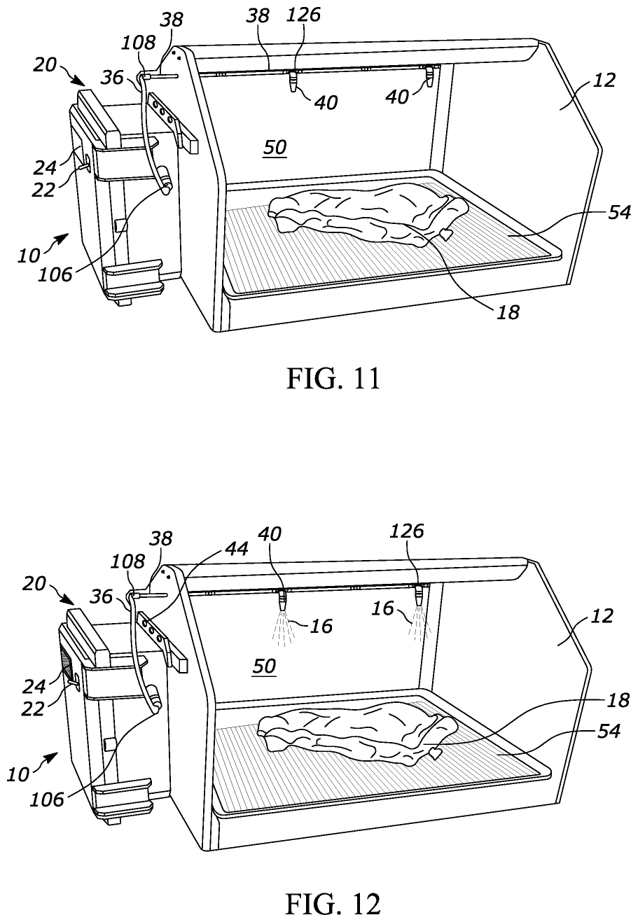

As depicted in FIGS. 1-3, the power controller 22 is connected to the control housing 20. As shown, the power controller 22 in some aspects is positioned through the control housing 20, and particularly through the door 76, such that a power interface 82 is accessible from an exterior of the control housing 20 while a remainder of the power controller 22 is positioned within the interior 74 of the control housing 20. This positioning allows interaction with the power controller 22 without the need to access the interior 74 of the container. In some aspects, the power interface 82 is a toggle switch that transitions between an off position as depicted in FIG. 11 and an off position as depicted in FIG. 12.

The spray controller 24 may also be connected to the control housing 20. As seen, the spray controller 24 may be positioned partially to the exterior of the control housing 20 and partially within the interior 74 of the control housing 20. When positioned as disclosed, a spray interface 84 of the spray controller 24 is accessible without accessing the interior 74 of the control housing 20. The spray interface 84 may have one or a plurality of buttons 86 (e.g., power button, set button, mode button, up button, down button, etc.) configured to modify operation of the operation of the spray controller 24 described herein. The spray controller 24 may also comprise a display 88 that is configured to display information related to the current settings of the spray assembly 10. For example, the display 88 may indicate the time remaining for the operation of the spray assembly 10, the time interval between operation, the defined volume or duration applied during operation, and/or the current input from the plurality of buttons 86. In certain aspects, the spray controller 24 is positioned through the door 76. In certain aspects, the spray controller 24 is a DDC-432 delay relay.

Other positions of the power controller 22 and/or the spray controller 24 are contemplated. Though such positions may not achieve the same advantages and benefits described herein. For example, the power controller 22 and/or the spray controller 24 may be positioned on the meat smoker system 12 to provide a unified positioning of all operation controls of the spray assembly 10 and meat smoker system 12. It is also contemplated that the power controller 22 and/or spray controller 24 are operatively controlled by a remote device such as a personal device (e.g., cell phone or computer tablet).

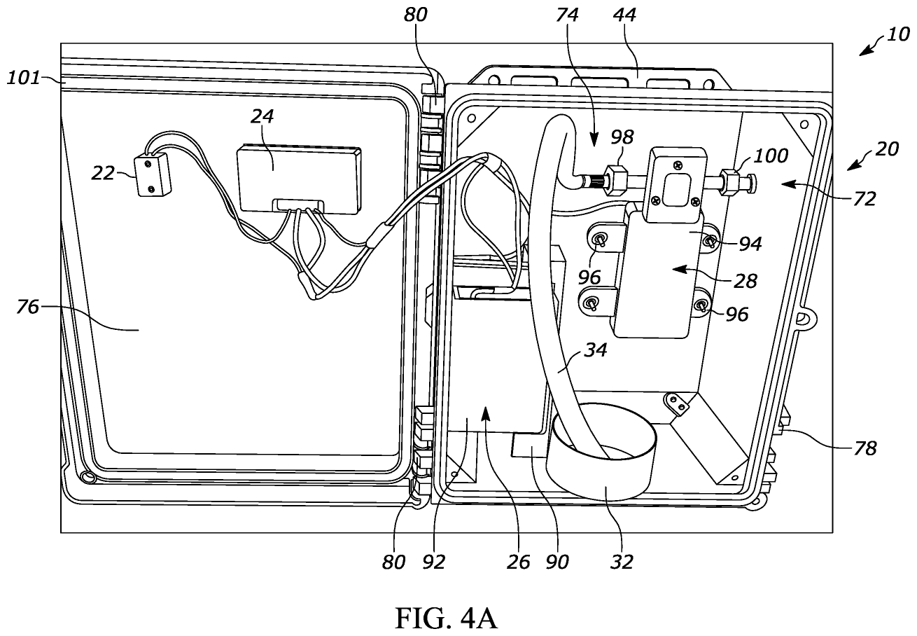

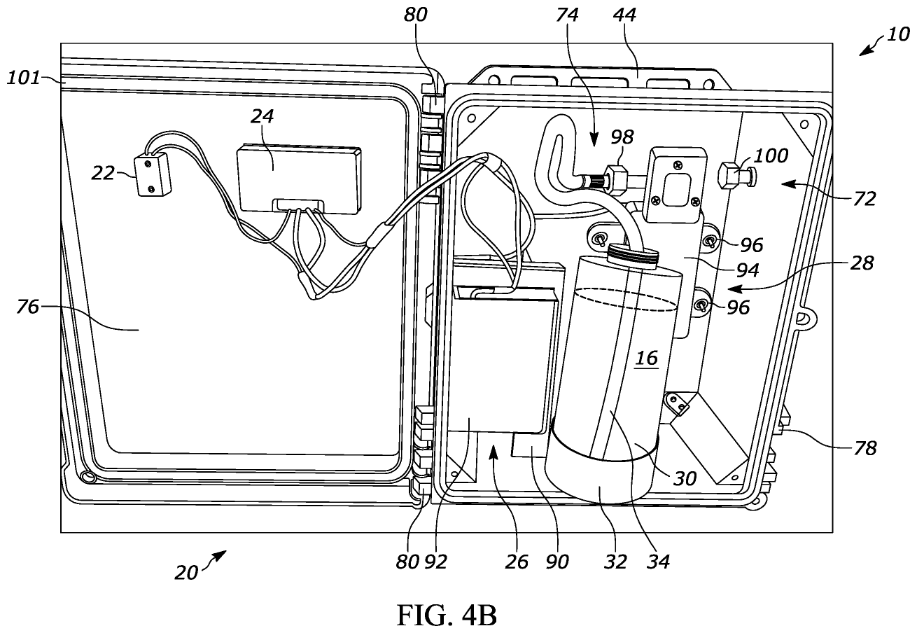

FIGS. 4A and 4B depict the interior 74 of the control housing 20. As discussed, a portion of the power controller 22 and/or the spray controller 24 may be positioned through the door 76 or other surface of the control housing 20. As shown, the power controller 22 may be electrically and/or operatively connected to the spray controller 24, the battery 26, and the pump 28. For instance, in the on position of the power interface 82, the power controller 22 activates the transmission of electricity from the battery 26 to the spray controller 24 and/or the pump 28. In the off position, the power controller 22 prevents such transmission.

The spray controller 24, in further aspects, is configured to activate the operation of the pump 28, including by way of permitting electricity to pass from the battery 26 to the pump 28 at one or more of a defined length, a defined interval, and a defined duration. The term “defined” refers to an end user input command or setting to the spray controller 24 via the spray interface 84 to set the defined length, defined interval, and/or defined duration and/or volume. In an illustrative example, the defined length is defined as eight hours, the defined interval is thirty minutes, and the defined duration is fifteen seconds, such that during the proceeding eight-hour period of time the pump 28 is activated every thirty minutes for fifteen seconds.

In additional aspects, the spray controller 24 is configured to activate the operation of the pump 28 based on one or more predefined settings selected with the spray interface 84. The term “predefined” refers to a command or setting of the spray controller 24 that is not defined by the end user and instead is stored in the spray controller 24. In some aspects, the predefined setting of the spray controller 24 is based on input from the end user related to one or more condition, such as a type of the meat product 18 and/or a weight of the meat product 18. In an illustrative example, the end user inputs that the meat product 18 is beef (or more specifically, a brisket) that weighs sixteen pounds, which prompts the spray controller 24 to operate under the predefined setting of the predefined length being twelve hours, the predefined interval being forty-five minutes, and the predefined duration being thirty seconds. In some aspects, the spray controller 24 can be set with both defined and predefined settings.

With further reference to FIGS. 4A and 4B, the battery 26 is removably connected to the control housing 20 by a battery bracket 90. The battery bracket 90 is configured to hold the battery 26 in place but selectively release the hold on the battery 26 such that the battery 26 can be disconnected from the spray assembly 10 and charged remotely from the spray assembly 10 and/or swapped with a replacement of the battery 26. As shown, the battery 26 may be mounted to the second side 70, which facilitates nesting in some configurations as discussed herein. In certain aspects, the battery bracket 90 is made of 6061 aluminum to provide a lightweight and rigid construction.

In further aspects, the battery 26 is positioned within a battery housing 92 that encases the battery 26 to prevent exposure to environmental conditions in addition to those protections provided by the control housing 20. In particular aspects, the battery 26 is 12V and 5 Ah that is configured to provide power for up to twenty hours. The battery 26 in other aspects may be an absorbed glass mat (AGM) battery that provides the advantage of providing electricity to the spray assembly 10 during an extended cook while also providing the battery 26 with low maintenance and cost.

In other aspects, the battery 26 is absent and electricity is drawn directly from the meat smoker system 12. In still other aspects, the power supply 26 is hard wired such that the spray assembly 10 can be plugged into a conventional power outlet.

The pump 28 in further aspects may comprise a pump housing 94 that is mounted to the control housing 20 by one or a plurality of pump mounts 96. In some aspects, the pump 28 is mounted to the rear 64 of the control housing 20 adjacent the first side 68—in contrast, as depicted the spray controller 24 is mounted to the door 76 such that when closed the spray controller 24 is adjacent the second side 70 of the control housing 20. The pump 28 may also comprise an inlet port 98 and an outlet port 100. The outlet port 100, in some aspects, is connected to the first side 68 such that connection to the outlet port 100 is accomplished externally to the control housing 20. As will be apparent from the discussion herein, the ability to externally couple to the outlet port 100 provides the advantage of providing an ease of removing the control housing 20 that may be desirable—for instance during freezing weather where damage to the pump 28 is possible due to the liquid 16 freezing within the pump 28. In particular aspects, the pump 28 is a 12V DC 70 W diaphragm pump.

As further depicted in FIGS. 4A and 4B, the reservoir 30 and the reservoir holder 32 may positioned on the bottom 67 of the control housing 20. The reservoir holder 32 may be positioned forward, i.e., nearer the door 76, of the pump 28 such that the reservoir 30 is positioned in front of the pump 28. The removable nature of the reservoir 30 as depicted by a comparison of FIGS. 4A and 4B, in some aspects, allows for simplified refilling of the reservoir 30 with the liquid 16 when the reservoir 30 becomes low or empty. In further aspects, the reservoir holder 32 may be mounted to the bottom 67 while the reservoir 30 is removably received within the reservoir holder 32, which may be cup shaped to conform to a shape of the reservoir 30 such that the reservoir 30 fits in a friction fit and/or snug seating with the reservoir holder 32 (i.e., such that the movement of the reservoir 30 from the reservoir holder 32 is not possible absent manual intervention by the end user). In an illustrative example, the reservoir holder 32 is circular and the reservoir 30 is cylindrical in shape with the diameter of the reservoir holder 32 being within a minimal tolerance of the exterior diameter of the reservoir 30. Alternatively, the reservoir 30 may be positioned outside the control housing 20 to limit the potential of the liquid 16 contained in the reservoir 30 from splashing or leaking to the electrical elements discussed herein. In further aspects, the reservoir 30 is made of a food grade metal and/or plastic, such as polyethylene, and/or the reservoir holder 32 is made of a rigid material such as stainless steel (e.g., 304 stainless steel).

As detailed, the positioning of certain aspects of the spray assembly 10 on the door 76 and other positions of the control housing 20 provides for the nesting of components, i.e., the elements are positioned to avoid contact with one another when the door 76 of the control housing 20 is closed. By nesting, the spray assembly 10 limits the size the spray assembly 10 occupies. Additionally, nesting provides the advantage of facilitating refilling of the liquid 16 as well as the repair and/or replacement of components as the aspects are separated when the door 76 is opened.

FIG. 4B shows the reservoir tubing 34 may connect to and between the inlet port 98 and the reservoir 30 such that during operation of the pump 28, the liquid 16 held in the reservoir 30 is drawn up the reservoir tubing 34 by the pump 28. In particular aspects, the reservoir tubing 34 is made of a food-grade polyethylene. Polyethylene provides the advantage of being food safe and being sufficiently flexible to permit simplistic withdrawal from the reservoir 30 when the reservoir 30 is refilled with the liquid 16. The reservoir tubing 34 may have an internal diameter of ⅜ of an inch with an external diameter of ½ of an inch as such dimensions allow for suitable operation while maintaining durability for a long product life.

As seen in FIG. 4A and FIG. 4B, the control housing 20 may also comprise a seal 101 that is configured to provide a watertight seal between the door 76 and the rest of the control housing 20 when the door is closed. As depicted, the seal 101 may be positioned around a perimeter or adjacent the perimeter of the door 76. The seal 101 prevents elements such as rain, insects, and the like from entering the control housing 20 when the door 76 is closed.

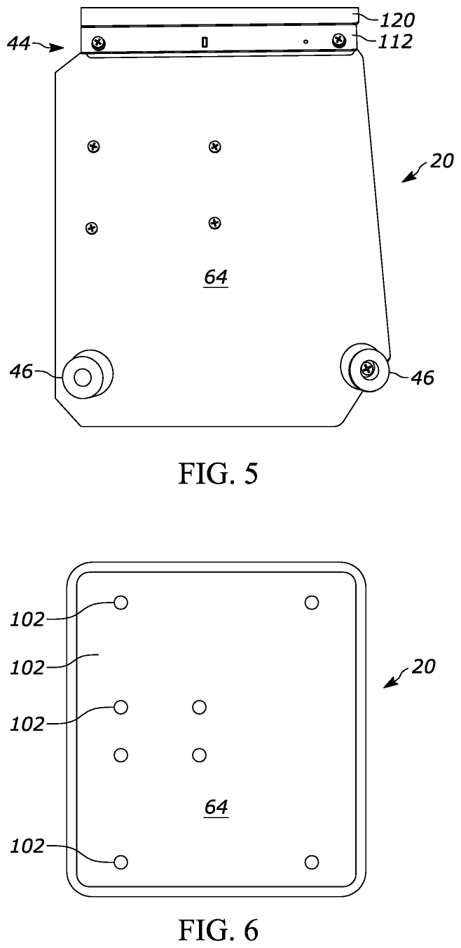

FIG. 5 and FIG. 6 depict the rear 64 of the control housing 20. Positioned adjacent the bottom 67 of the control housing 20, the rear 64 of the control housing 20 have the bumper assembly 46 connected. The bumper assembly 46 is configured to engage the meat smoker system 12 when the spray assembly 10 is hung from the meat smoker system 12 as discussed further herein. As also shown in FIG. 5, the hanger 44 may be connected to the rear 64 of the control housing 20 adjacent the top 66. The hanger 44 is configured to hang from the meat smoker system 12 as discussed further herein. When hung, the bumper assembly 46 positioned the control housing 20 substantially vertically—substantially perpendicular to a ground surface—such that the reservoir 30 is held level to avoid spillage of the liquid 16. The bumper assembly 46 may be made of rubber to prevent damage to the meat smoker system 12.

FIG. 6 further depicts a plurality of apertures 102 that are positioned to allow the hanger 44, the bumper assembly 46, and the plurality of pump mounts 96 to connect to the control housing 20. While the depicted examples are shown on the rear 64 of the control housing 20, other positioning is contemplated and fall within the scope of the disclosure, e.g., the front 62, the bottom 67, the first side 68, etc.

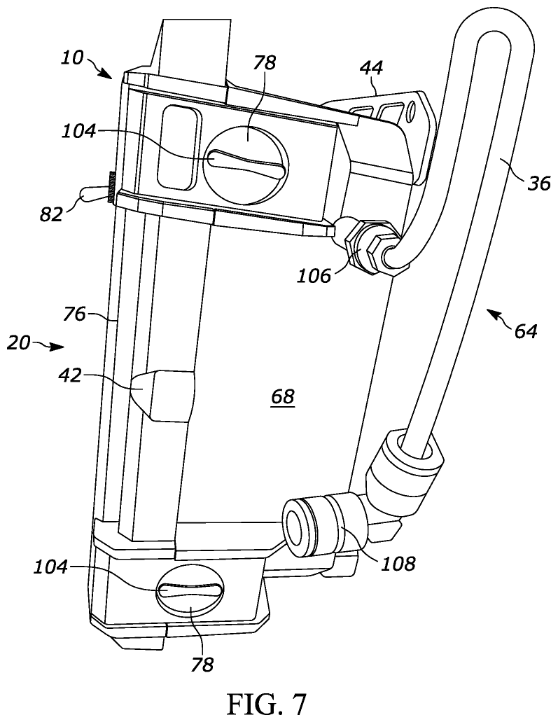

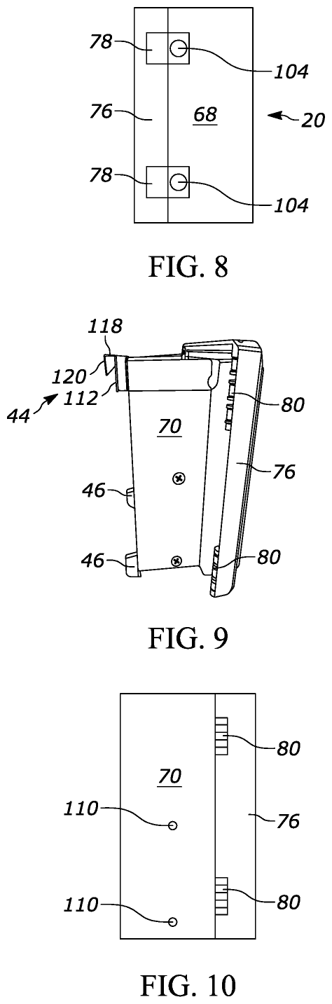

FIGS. 7 and 8 depict further aspects of the control housing 20. As shown, the first side 68 may have the plurality of locks 78, which in this example, are turnstile locks having a rotatable knob 104 that transitions each of the plurality of locks 78 between a locked position that prevents the door 76 from opening and an unlocked position that allows the door 76 to open. The use of such a style for the plurality of locks 78 provides for simplistic use and quick locking and unlocking.

FIG. 7 also depicts the external distribution tubing 36 that connects or couples to the outlet port 100 positioned through the first side 68 of the control housing 20. The external distribution tubing 36 may have a distribution inlet port 106 that is configured to couple to the outlet port 100. The external distribution tubing 36 is configured to transport the liquid 16 between the control housing 20 of the spray assembly 10 and the meat smoker system 12. The external distribution tubing 36 may also comprise a distribution outlet port 108 that is configured to couple to the internal distribution tubing 38. In some aspects, the distribution outlet port 108 is configured to be manually removable (i.e., without the use of tools or component disassembly) to the internal distribution tubing 38, such as press fit, compression fit, and/or friction fit while maintaining a watertight seal. A similar configuration is contemplated for the inlet port 98, the outlet port 100, and the distribution inlet port 106. The external distribution tubing 36 may be made of a food-grade polyethylene material and/or may have an internal diameter of ⅜ of an inch with an external diameter of ½ of an inch as such dimensions allow for suitable operation while maintaining a durability for a long product life.

FIGS. 9 and 10 show additional aspects of the control housing 20. The control housing 20 may comprise the plurality of hinges 80 being integrated into the second side 70 and the door 76 to provide for the hinged connected between the two. Additionally, a pair of apertures 110 are positioned on the second side 70 to allow connection of the battery bracket 90.

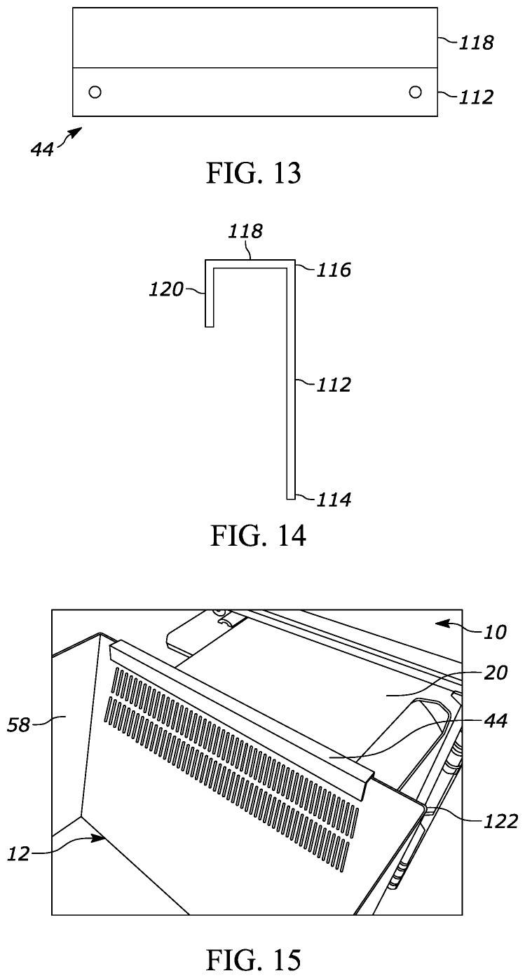

As shown in FIG. 9 (and FIGS. 13, 14, and 15), the hanger 44 may be connected to the rear 64 of the control housing 20 adjacent the top 66 such that a portion of the hanger 44 extends above the top 66. In some aspects, the hanger 44 comprises a first vertical portion 112 that connects to the control housing 20 adjacent a first end 114. The first vertical portion 112 extends from the first end 114 to a second end 116 from which a horizontal portion 118 extends generally perpendicularly from the first vertical portion 112 to a second vertical portion 120, which extends downwardly in a perpendicular relation to the horizontal portion 118 and parallel relation to the first vertical portion 112. In this way, the second vertical portion 120 and the horizontal portion 118 can be engaged with the meat smoker system 12 while the bumper assembly 46 maintains the control housing 20 in an upright position. As shown in FIG. 15, the hanger 44 is positioned over a lip 122 of the hopper 58 such that the spray assembly 10 is positioned away from the heat of the meat smoker system 12 during operation of each. As shown in FIG. 14, the first vertical portion 112 may be longer than the second vertical portion 120 to facilitate positioning, hanging, and removal, while also conserving materials. In some aspects, the hanger 44 is made of 304 stainless steel. In other configurations, the control housing 20 is hung (FIG. 11) or affixed to the meat smoker system 12 and/or integrated in whole or in part to the smoke chamber 50 and/or frame 48.

FIGS. 11 and 12 depict further aspects of the spray assembly 10. As shown, the internal distribution tubing 38 extends across a top 124 of the smoke chamber 50 within the smoke chamber 50. The internal distribution tubing 38 may also extend partially to an exterior of the smoke chamber 50 to allow the distribution outlet port 108 to couple to the internal distribution tubing 38 a distance away from the heat contained in the smoke chamber 50 during operation.

The internal distribution tubing 38 may comprise the nozzle 40 or a plurality of the nozzle 40 spaced out along a length of the internal distribution tubing 38 within the smoke chamber 50. As depicted, two of the nozzle 40 are positioned equidistantly within the smoke chamber 50 such that during operation a generally uniform application of the liquid 16 occurs. Each of the nozzle 40 may be connected by a branch 126 such as a ¼ female branch TEE that interconnects with the internal distribution tubing 38 by press fit, friction fit, and/or compression fit. In other aspects, the nozzle 40 may be configured to apply a spritz or spray of the liquid 16 in a conical and/or radial arrangement to facilitate event application. In still other aspects, the nozzle 40 may be made of 303 stainless steel, the branch 126 may be made of 316 stainless steel, and the internal distribution tubing 38 made of 304 stainless steel. While the Figures depict two of the nozzle 40 any number is contemplated.

In still other aspects, the external distribution tubing 36 may have a larger internal diameter in comparison to the internal distribution tubing 38. In such a configuration, the liquid 16 is pressurized when entering the internal distribution tubing 38 from the external distribution tubing 36.

The example operation of the spray assembly 10 is depicted in FIGS. 11 and 12. As seen in FIG. 11, the control housing 20 is hung on the side of the smoke chamber 50 with the hanger 44. Positioned within the control housing 20 (as seen in. FIG. 4B), the reservoir 30 is filled with the liquid 16, such as a brine.

FIG. 12, shows the power interface 82 being used to activate the power controller 22 thereby turning on the spray assembly 10. Using the spray interface 84, the spray controller 24 is set with defined or predefined settings as discussed herein. Based on these settings, the liquid 16 is applied to the meat product 18 positioned on the grill grate 54. For instance, the pump 28 draws the liquid 16 from the reservoir 30 by way of the reservoir tubing 34 and thereafter discharges the liquid 16 through the external distribution tubing 36 that then is further pressurized when it enters the internal distribution tubing 38. The liquid 16 is then discharged by the nozzle 40 until the defined or predefined settings are executed.

After or during the cook, the reservoir 30 may be removed by unlocking the door 76 of the control housing 20 and retrieving the reservoir 30 from the reservoir holder 32. Once refilled, the reservoir 30 is replaced in the reservoir holder 32. If the battery 26 is low or empty, the battery 26 is removed from the battery bracket 90 and disconnected from the other components to allow remote charging. Once charged, the battery 26 is replaced and held in place by the battery bracket 90.

Therefore, a spray assembly 10 for a meat smoker system 12 has been provided that is programmable to apply a spray of a liquid at a definable interval of time and/or a definable amount of the liquid, can be retrofitted to the meat smoker system, is user friendly, cost-effective, and easily maintained, and improves upon the art.

From the above discussion and accompanying figures and claims it will be appreciated that the spray assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

For a firmware and/or software implementation of the power controller 22 and/or spray controller 24, the methodologies may be implemented with modules (e.g., procedures, functions, routines and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored. If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage, solid state or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Those of skill would further appreciate that the various aspects described in connection with the disclosure herein may be implemented as electronic hardware, computer software, or combinations of both. To clearly illustrate this interchangeability of hardware and software, various aspects may have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various aspects described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The aspects described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, solid state storage, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. In yet other aspects, the processor can be remote to the storage medium and accesses the storage medium through a linked connection.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, solid state, or any other medium that can be used to carry or store specified program code means in the form of instructions or data structures and that can be accessed by a general-purpose or special-purpose computer, or a general-purpose or special purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In the present disclosure, the processor may serve as a structure for computer-implemented functions as described herein because the function(s) described in one or more aspects of the present disclosure are coextensive with the processor itself. Further, such a processor may serve as structure for functions that may be achieved by a general-purpose computer without special programming, because the coextensive functions include receiving data, storing data, processing data, etc. Further, the present disclosure are removed from the abstract, and do not merely limit the use of an abstract idea to a particular technological environment. The present disclosure expands basic building blocks beyond the mere sum of the parts, at least for the reason that the present disclosure provides faster, more consistent, and more reliable results than obtainable with current methods and devices.

What is claimed is:

1. A spray assembly comprising:
a control housing having a compartment with an interior;
a power controller and a spray controller connected the control housing;
a power supply, a pump, and a reservoir positioned within the compartment;
wherein the spray controller is configured to operate the pump to draw a liquid contained in the reservoir through the pump to a nozzle that discharges the liquid.

2. The spray assembly of claim 1 further comprising the power controller and the spray controller positioned through a door of the control housing such that the power controller and the spray controller nests with the power supply, the pump, and the reservoir when the door is in a closed position.

3. The spray assembly of claim 1 wherein the spray controller is configured to activate the operation of the pump for a defined length of time, a defined interval between activation of the pump, and a defined duration of activation of the pump.

4. The spray assembly of claim 1 wherein the spray controller is configured to activate the operation of the pump for a predefined length of time, a predefined interval between activation of the pump, and a predefined duration of activation of the pump.

5. The spray assembly of claim 4 wherein the predefined length, the predefined interval, and the predefined duration is based on a user input.

6. The spray assembly of claim 5 wherein the user input is a weight of a meat product.

7. The spray assembly of claim 5 wherein the user input is a type of a meat product.

8. The spray assembly of claim 1 wherein the spray controller is configured to activate the pump based on a defined setting and a predefined setting.

9. The spray assembly of claim 1 further comprising the pump connected to an external distribution tubing that connects to an internal distribution tubing, wherein the internal distribution tubing has the nozzle.

10. The spray assembly of claim 9 further comprising the external distribution tubing having a distribution outlet port that couples with the internal distribution tubing with a compression fit, wherein the external distribution tubing is manually removable.

11. The spray assembly of claim 1 further comprising a rear of the control housing having a bumper assembly and a hanger.

12. The spray assembly of claim 11 wherein the bumper assembly is configured to maintain the control housing in an upright position when the hanger is hung from a meat smoker assembly.

13. The spray assembly of claim 1 wherein the nozzle is configured to discharge the liquid in a conical arrangement.

14. The spray assembly of claim 1 wherein the nozzle comprises a plurality of nozzles positioned equidistantly along an internal distribution tubing.
